(19) United States
(12) Patent Application Publication
(10) Pub. No.: US 2011/0282833 A1
(43) Pub. Date: Nov. 17, 2011

(54) PROVIDING ADMINISTRATIVE CAPABILITIES IN A MULTI-TENANT DATABASE ENVIRONMENT

(75) Inventors: Michael Ramsey, Foster City, CA (US); Rachel Wang, Foster City, CA (US); Gautam Vasudev, San Francisco, CA (US)

(73) Assignee: Salesforce.com, inc., San Francisco, CA (US)

(21) Appl. No.: 12/970,591

(22) Filed: Dec. 16, 2010

Related U.S. Application Data
(60) Provisional application No. 61/333,702, filed on May 11, 2010.

(51) Int. Cl. G06F 17/30

(52) U.S. Cl. 707/609; 707/E17.005

(57) ABSTRACT

A system and method for providing administrative capabilities in a multi-tenant database system. In one embodiment, a method includes providing a portal for a database system to a user, providing administrative capabilities through the portal, and enabling the user to manage objects in the database system using the administrative capabilities.

### CLAIM OF PRIORITY

This application claims the benefit of U.S. Provisional Patent Application 61/333,702 entitled, “Methods and Systems for Providing Administrative Capabilities to a Portal in a Multi-Tenant Data Base Environment,” filed May 11, 2010 (Attorney Docket No. SALEP0003P), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to a database network system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which, in and of themselves, may also be inventions.

In conventional database systems, users access their data resources in one logical database. A user of such a conventional system typically retrieves data from and stores data on the system using the user's own systems. A user system might remotely access one of a plurality of server systems that might in turn access the database system. Unfortunately, management of database systems can be difficult and complex.

### BRIEF SUMMARY

Embodiments provide mechanisms and methods for providing administrative capabilities in a multi-tenant database system. In one embodiment, a method includes providing a portal for a database system to a user, providing administrative capabilities through the portal, and enabling the user to manage objects in the database system using the administrative capabilities.

While one or more implementations and techniques are described, one or more embodiments may be implemented in a system having an application server providing a front end for an on-demand database service capable of supporting multiple tenants. The embodiments described herein are not limited to multi-tenant databases or deployment on application servers. Embodiments may be practiced using other database architectures, i.e., ORACLE®, DB2® by IBM and the like, without departing from the scope of the embodiments claimed.

Any of the above embodiments may be used alone or together with one another in any combination. Embodiments described herein may also include embodiments that are only partially mentioned or alluded to, or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the embodiments described are not limited to the examples depicted in the figures.

FIG. 1 illustrates a block diagram of an example environment, which may be used to implement the embodiments described herein.

FIG. 2 illustrates an example simplified flow diagram for providing administrative capabilities in a multi-tenant database system, according to one embodiment.

FIG. 3 illustrates a block diagram of an example environment where a database service might be used, and which may be used to implement the embodiments described herein.

FIG. 4 illustrates a block diagram of another example environment, which may be used to implement the embodiments described herein.

### DETAILED DESCRIPTION

### General Overview

Systems and methods provide administrative capabilities through a portal in a multi-tenant database environment.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for providing administrative capabilities through a portal in a multi-tenant database environment will be described with reference to example embodiments.

### System Overview

Embodiments described herein provide administrative capabilities in a multi-tenant database system, such as an on-demand database services system. Embodiments provide administrative functionality required to manage information associated with partners and end-customers. Embodiments enable users to perform important account and contact level transactions such as disabling, merging, and transferring capabilities. In one embodiment, these functionalities are subsets of a greater customer master functionality that maintains the quality of data associated with partners and end-customers' accounts, contacts, and other related data.

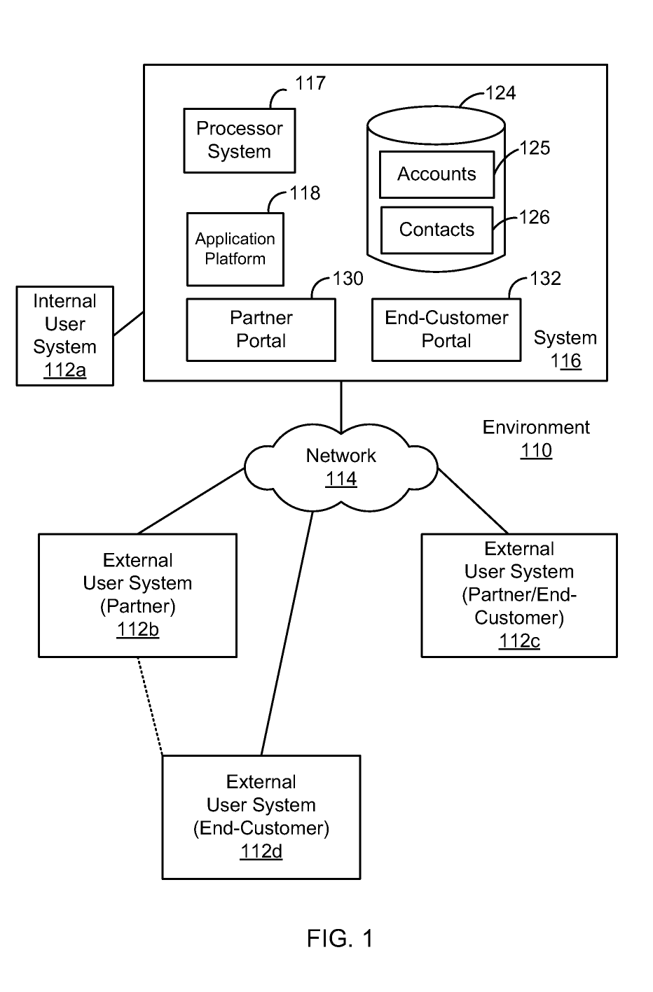

FIG. 1 illustrates a block diagram of an example environment 110, which may be used to implement the embodiments described herein. In one embodiment, environment 110 includes one or more user systems 112, a network 114, and a system 116. In one embodiment, system 116 is a multi-tenant database system, such as an on-demand database services system.

In one embodiment, system 116 also includes a processor system 117, an application platform 118, and system data storage 124. In one embodiment, system data storage 124 stores information associated with accounts 125 and information associated with contacts 126. In one embodiment, system 116 also includes partner portal 130 and end-customer portal 132. In other embodiments, environment 110 may not have all of the components listed and/or may have other elements instead of, or in addition to, those listed above.

For ease of illustration, some user systems 112 (e.g., internal user system 112a) are designated as internal user systems in that users internal to the organization operating and maintaining the platform of system 116 (e.g., network administrators, engineers, managers, etc.) typically use internal user systems to access system 116. In the embodiments described herein, these users may be referred to as internal users.

Some user systems 112 (e.g., external user systems 112b, 112c, and 112d) are designated as external user systems in that users external to the organization, which is operating and maintaining the platform of system 116, use external user systems to access system 116. In the embodiments described herein, these users may be referred to as external users. External users may include partners. Partners, in this context, include customers who use the resources of system 116 as a service. As shown in the example of FIG. 1, these external users (partners) access system 116 via external user systems 112b and 112c. A given partner may in turn have a direct customer, who uses the resources of system 116 as a service. A direct customer of a partner may be referred to as an end-customer. As shown in the example of FIG. 1, this external user (end-customer) accesses system 116 via external user system 112d. The dotted line between external user system 112b and external user system 112d indicates a business relationship between the users of these user systems. Note that a given partner may also be an end-customer, for example, when that partner does not have a direct customer (e.g., as indicated by external user system 112c of FIG. 1).

For ease of illustration, FIG. 1 shows one block for each of user systems 112, processor system 117, system data storage 124, partner portal 130, and end-customer portal 132. These blocks 112, 117, 124, 130, and 132 may represent multiple user systems (internal and external user systems), processor systems, system data storage units, partner portals, and end-customer portals.

In one embodiment, different partner users may access the same partner portal 130, and different end-customers may access the same end-customer portal 132. In another embodiment, a given partner user may access different partner portals, and a given end-customer may access different end-customer portals. In another embodiment, partner users and end-customer users may access the same portal.

As described in more detail below, in one embodiment, system 116 performs functions for managing accounts and contacts. In this embodiment, a given account may be associated with one or more external users, such as a partner user or end-customer user. For purposes of clarity, while a given external user may be a partner, end-customer, or partner/end-customer, as indicated above, the embodiments described herein primarily refer to external users that are partners with end-customers, and end-customers who are not partners. This is because some embodiments treat external users that are partners differently from external users that are non-partner end-customers.

In one embodiment, system 116 associates an account object to each user system that is an external organization (e.g., external to the organization that operates and maintains the platform of system 116) and that accesses system 116 for database services (e.g., on-demand database services). In one embodiment, system 116 associates a contact object to one or more external users in each external organization. As described in more detail below, an external user may also be referred to as a portal user, because such external users access system 116 via a portal. In one embodiment, each account is associated with one or more contacts.

In one embodiment, system 116 provides one or more external users with administrative capabilities for managing accounts and contacts. These external users may also be referred to as delegated portal user administrators. With their administrative capabilities, a delegated portal user administrator, according to one implementation, manages accounts and contacts for other external users within the same external organization.

In one embodiment, internal users manage external users' rights in a similar manner that internal users internal users' rights. In one embodiment, a given external user is associated to a particular license with particular permissions and capabilities, and the external user is associated to a profile with particular permissions and capabilities. For example, these permissions and capabilities may include controlling visibility, creating objects, reading objects, updating objects, etc. In one embodiment, system 116 delegates a subset of rights to external portal users (e.g., delegated portal user administrators). This subset of rights may include certain administrative rights though user profiles.

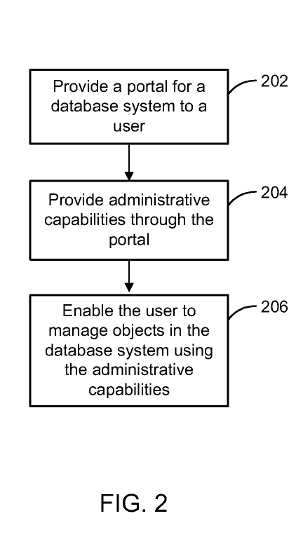

FIG. 2 illustrates an example simplified flow diagram for providing administrative capabilities in a multi-tenant database system, according to one embodiment. Referring to both FIGS. 1 and 2, the method is initiated in block 202, where system 116 provides a portal for a database system (e.g., system 116) to an external user. In one embodiment, the user may access the portal via a user system (e.g., user system 112). In one embodiment, the portal enables the user to access the database system. In one embodiment, the portal is a self-service portal in that the external user may manage accounts and contacts associated with the external user's organization.

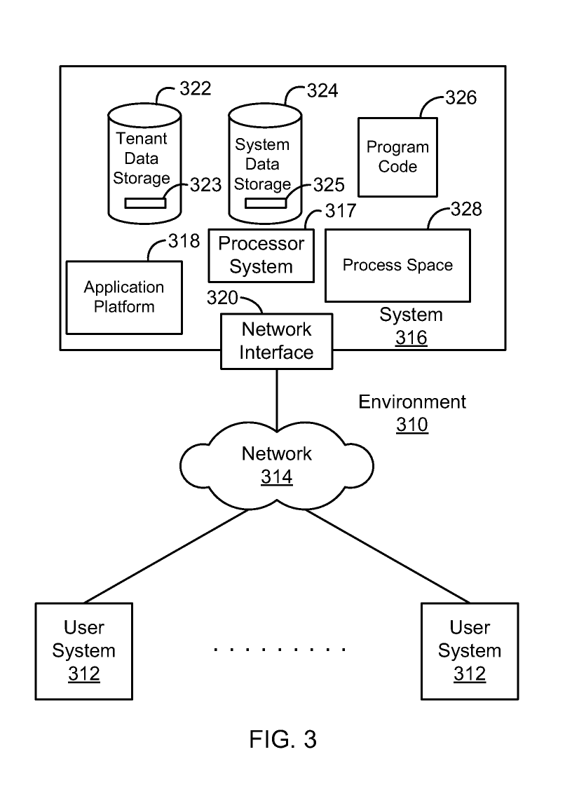

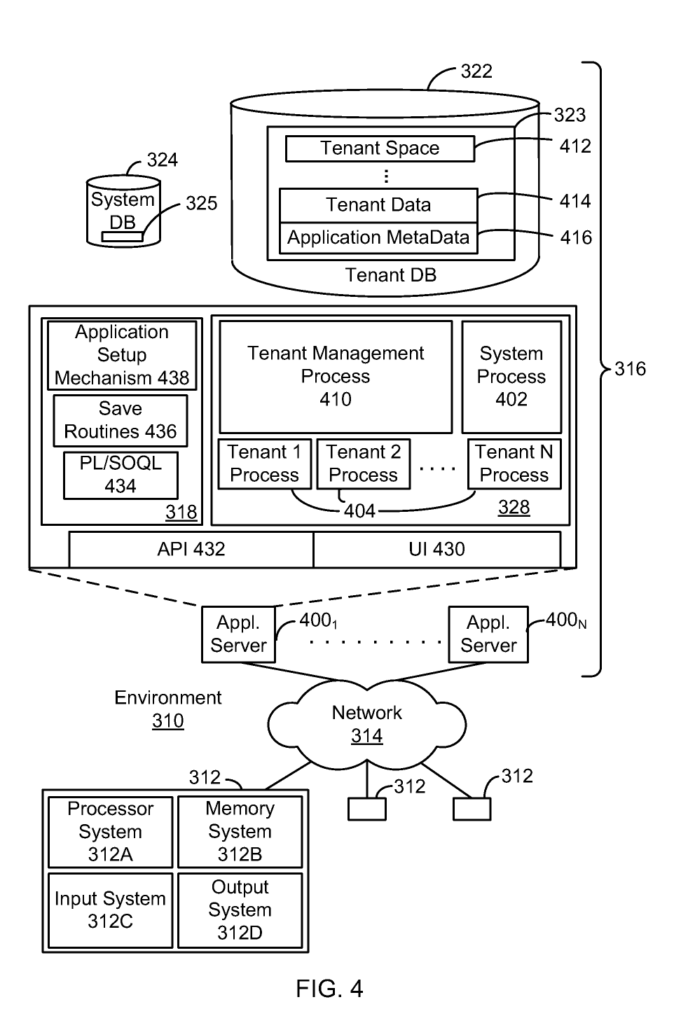

While system 116 is described as performing the steps as described in the embodiments herein, any suitable component or combination of components of system 116 or any suitable processor or processors associated with system 116 may perform the steps described. For example, the steps may be performed by processor system 317 or process space 328 of FIG. 3, by system process 402 of FIG. 4, or by any other suitable processor or processors associated with system 116.

In block 204, the system 116 provides administrative capabilities through the portal. In one embodiment, the administrative capabilities include disabling capabilities, merging capabilities, and transferring capabilities.

In block 206, the system 116 enables the user to manage objects in the database system using the administrative capabilities. In one embodiment, the objects include accounts and contacts. In one embodiment, these objects are associated with an entity associated with the user. Such an entity may be an organization or company (e.g., partner or end-customer) to which the user is associated. In one embodiment, an account may be associated with a partner or end-customer, and each account may be associated with one or more contacts. As indicated above, each contact is associated with an external user. In one embodiment, system 116 provides partners with partner portals and provides end-customers with end-customer portals. In one embodiment, partner portals may be referred to as partner relationship management (PRM) portals, and end-customer portals may be referred to as customer service portals (CSP). In one embodiment, partner portals and end-customer portals share the same architecture, but may have different functionality.

In one embodiment, an account may be a PRM account or a CSP account, where a PRM account is enabled as a partner and contains zero or more PRM contacts. An account is considered a CSP account if the account contains any CSP contacts.

As indicated above, the administrative capabilities provided to portals enable an external user to manage accounts and contacts, where such administrative capabilities may include disabling capabilities, merging capabilities, and transferring capabilities. Example embodiments of these capabilities are described in more detail below.

Disabling Accounts

As indicated above, in one embodiment, the administrative capabilities include disabling capabilities. The following embodiments involve the disabling of accounts. In one embodiment, the disabling of an account involves the disabling of a portal account.

In one embodiment, system 116 enables a user to disable an account at some point after the account was enabled. For example, such an action is the equivalent of an “undo” button. In one embodiment, system 116 may provide a toggle button that toggles between “Enable” and “Disable.” In one embodiment, system 116 may distinguish between an account that is a partner portal and an account that is an end-customer account. Accordingly, in one embodiment system 116 may provide respective “Disable Partner Portal Account” and “Disable End-Customer Portal Account” buttons.

In terms of the user interface (UI) design, in one embodiment, a disable button may appear only if the account is enabled for a given partner or end-customer portal. In other words, an enable button and a disable button would not appear at the same time.

In one embodiment, when an account is disabled, system generated objects such as user(s), role(s), and group(s) may be physically and/or logically deleted depending on data integrity requirements. In one embodiment, in the case where system generated objects such as roles and groups are not related to other records, system 116 provides an option to physically delete them, such as in the case where they were created in error. Physically deleting these records removes the negative impact on edit list views, reports, and any page that may include roles and groups for the entire organization.

In one embodiment, in order to disable an account, the account should not have any contacts enabled for a portal. Accordingly, if an account has one or more contacts enabled for a portal, system 116 would disable contacts in order to disable the account from portal use.

In one embodiment, when an active portal user under an account is deactivated from portal use, system 116 removes the entry for the user in a core portal account and the user's associated roles and groups. In one embodiment, the account may be re-enabled again for portal use.

Merging Accounts

As indicated above, in one embodiment, the administrative capabilities include merging capabilities. The following embodiments involve the merging of accounts.

In one embodiment, system 116 enables a user to merge two or more accounts into one account. In one embodiment, the surviving account (e.g., the one remaining account) in a merge transaction inherits all related objects from all victim accounts (e.g., the merged accounts that will no longer exist).

In one embodiment, system 116 may provide the user with a list of accounts, where the user may select (e.g., by checking boxes) the accounts to merge and which account is be the surviving account. In one embodiment, the user selects the account that becomes the surviving account, whereas the remaining/non-selected accounts become victim accounts. Note that a surviving account may also be referred to as a master account, and a victim account may also be referred to as a slave account.

In one embodiment, this merging action translates to replacing any victim account foreign keys with the surviving account foreign keys throughout the organization (e.g., throughout system 116). In one embodiment, there may be exceptions such as portal objects which support a 1:1 relationship with an account. For example, if the survivor account is already portal enabled or if more than one victim account is portal enabled, then there will be more than one user role record of type of executive/manager/user.

In one embodiment, system 116 performs an account merge transaction as a transaction that would provide an audit trail. In one embodiment, the existing UI may be leveraged.

Disabling Contacts

As indicated above, in one embodiment, the administrative capabilities include disabling capabilities. The following embodiments involve the disabling of contacts.

In one embodiment, system 116 enables a user to disable a contact at some point after the portal user was enabled. For example, such an action is the equivalent of an “undo” button. This restores the contact to non-portal status.

In one embodiment, a user associated with a contact may also be referred to as a portal user. In one embodiment, system 116 may distinguish between partner portal users and end-customer portal users. Accordingly, in one embodiment, system 116 may provide “Disable End-Customer Portal User” buttons and “Disable Partner Portal User” buttons.

In one embodiment, a portal user may be active or inactive when detached from a portal. In one embodiment, system 116 may update the portal user to inactive, remove the portal user's contact identification and user role, and remove this portal user from all groups (e.g., teams) associated with the portal user.

In one embodiment, system 116 updates sharing capabilities while updating roles. A detached portal user object should not be re-enabled, resulting in potentially many unused rows of core users. In one embodiment, if the deactivated user object is edited, system 116 may prevent its active field from being edited, and then save the validation.

In one embodiment, a contact may be re-enabled as a portal user, which creates a new user object with a unique user name. When the last partner or end-customer portal user/contact is disabled as portal, the account is left as portal-enabled, to separate the concept of contact and account level operations.

In one embodiment, the detached user object remains, because user objects are not physically deleted. In one embodiment, records owned by the portal user are still owned by the portal user, and are accessible to the system administrator or users with modify-all-data and read-all-data permissions.

In one embodiment, because the portal role is removed, sharing rules no longer assume there is a parent role. In one embodiment, system 116 updates boss-implicit sharing, parent-implicit sharing, and related portal shares. In one embodiment, system 116 removes related boss-implicit shares, parent-implicit shares, and related portal shares.

In one embodiment, a transaction may have forecasting and visibility implications for partner users, because the role hierarchy will change if a role is removed. In addition, deactivated user records may still own records such as opportunities. In one embodiment, user records are logically deleted (e.g., soft deleted) to avoid loss of data integrity and history.

Merging Contacts

As indicated above, in one embodiment, the administrative capabilities include merging capabilities. The following embodiments involve the merging of contacts.

In one embodiment, the surviving contact (e.g., the one remaining contact) in a merge transaction inherits all related objects from all victim contacts (e.g., the merged contacts that will no longer exist).

In one embodiment, system 116 may provide the user with a list of contacts, where the user may select (e.g., by checking boxes) the contacts to merge and which contact is to be the surviving contact. In one embodiment, the user who selects the contact becomes the surviving contact, whereas the remaining/non-selected contact become victim contacts. Note that a surviving contact may also be referred to as a master contact, and a victim account may also be referred to as a slave contact.

In one embodiment, this translates to replacing any victim contact foreign keys with the surviving contact foreign keys throughout the organization (e.g., throughout system 116). In one embodiment, there may be exceptions such as portal objects which support a 1:1 relationship with a contact. For example, if the survivor contact is already portal enabled or if more than one victim contact is portal enabled then there will be more than one user record. In one embodiment, ownership changes need not be part of the contact merge transaction. Accordingly, in one embodiment, records that are owned by a victim contact user will remain associated to the inactive user record after the merge transaction. In one embodiment, a contact merge transaction may be performed as a transaction that provides an audit trail.

In one embodiment, while the UI design may be leveraged for this feature, system 116 may allow a merging of contacts across accounts. In one embodiment, the ability to merge contacts across accounts may be accomplished by first transferring contacts to the same account, and then performing the merge transaction. In one embodiment, a merge link may be included in a tools page on a contact tab (as in an account tab).

In one embodiment, in order to be consistent with the existing contact merge functionality, system 116 enables the user (e.g., delegated portal user administrator) performing the merge to select which contact should survive the transaction. For example, if a contact that is enabled for the portal is being merged with a contact which is not enabled for the portal, the user may determine if the surviving contact is portal enabled or not. In one embodiment, for a scenario where more than one portal enabled contact is being merged, then the user performing the merge transaction determines which contact survives.

Note that, in one embodiment, the contact merge feature should be exposed to end-customer portal users (e.g., delegated portal user administrators). In one embodiment, because access to the feature may be controlled via contact entity profile permissions, customers can conditionally expose the feature to their end-customers. In general, most customers prefer to delegate the administration of customer data to their end-customers. Not only is the end-customer the authority on their own account and contact data in terms of names, addresses, etc., but there may be legal requirements that any changes to customer data be approved or validated by the customer in question. Note that portal contacts are enabled to access portals, and non-portal contacts are not enabled to access portals. The embodiments described herein are primarily directed to portal contacts, and the terms “contact” and “portal contact” are used interchangeably, unless otherwise indicated.

In one embodiment, system 116 enables a user to merge a partner portal contact into an end-customer portal contact, where the user selects the end-customer portal contact to be the surviving contact. In one embodiment, a partner portal contact merged into an end-customer portal contact results in an end-customer contact. In one embodiment, since only portal contacts are merged, not the associated portal users, system 116 will deactivate the partner contact's corresponding portal user, and merges the two contacts. Records owned by the victim contact are transferred to the surviving contact, and records owned by the victim contact's portal user will remain.

In one embodiment, system 116 enables a user to merge an end-customer portal contact to a partner portal contact, where the user selects the partner portal contact to be the surviving contact. In one embodiment, an end-customer portal contact merged into a partner portal contact results in a partner portal contact. In one embodiment, system 116 deactivates the end-customer contact's corresponding portal user, and merges the two contacts.

In one embodiment, when a first portal contact is merged into a second portal contact, where the user selects the second portal contact to be the surviving portal contact, system 116 deactivates the victim portal contact's corresponding user, and then merges the portal contacts.

In one embodiment, when there are multiple portal victim contacts, system 116 enables the user to select the corresponding portal user to keep.

In one embodiment, when a non-portal contact is merged into a portal contact, the master portal's roles remain, and system 116 merges the contacts.

In one embodiment, when a portal contact is merged into a non-portal contact, system 116 moves the victim portal contact's corresponding user under the surviving contact by updating the user record's contact identification, and then merges the contacts. In one embodiment, when there are multiple portal slave contacts, system 116 enables the user to select the corresponding portal user to keep. In one embodiment, sharing is left alone, because the contacts are in the same account.

In one embodiment, system 116 may also allow a non-portal contact to be merged into another non-portal contact.

In one embodiment, the following merge transaction scenarios may have the following results, as shown in Table 1 below.

TABLE 1

| Victim Contact | Survivor Contact | Resulting Contact |
|---|---|---|
| portal | portal | portal |
| non-portal | portal | portal |
| portal | non-portal | portal |
| non-portal | non-portal | non-portal |

Transferring Contacts

As indicated above, in one embodiment, the administrative capabilities include transferring capabilities. The following embodiments involve the transferring of contacts. Note that a given contact may be referred to as a portal-enabled contact. In one embodiment, a portal-enabled contact may be designated as a partner-portal contact or an end-customer-portal contact.

In one embodiment, system 116 may allow the ability to change a portal-enabled contact from one account to another. For example, if given an Account A and a Contact A (among other contacts), system 116 may allow a user to transfer Contact A to an Account B.

In one embodiment, system 116 may not allow the ability to change the account on a portal-enabled contact when transferring a partner-portal contact to an account which has not been enabled as a partner.

FIG. 3 illustrates a block diagram of an example environment 310 where a database service might be used, and which may be used to implement the embodiments described herein. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

Environment 310 is an environment in which an on-demand database service exists. User system 312 may be any machine or system that is used by a user to access a database user system. For example, any of user systems 312 can be a handheld computing device, a mobile phone, a laptop computer, a work station, and/or a network of computing devices. As illustrated in FIG. 3 (and in more detail in FIG. 4) user systems 312 might interact via a network 314 with an on-demand database service, which is system 316. System 316 may also be referred to as a cloud service provider. System 316 provides its resources to customers (e.g., end users) as a service.

An on-demand database service, such as system 316, is a database system that is made available to outside users who do not need to necessarily be concerned with building and/or maintaining the database system, but instead may be available for more general use when the users need the database system (e.g., on the demand of the users). Some on-demand database services may store information from one or more tenants stored into tables of a common database image to form a multi-tenant database system (MTS). Accordingly, “on-demand database service 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, system 316 may include an application platform 318 that enables creating, managing, and executing one or more applications developed for an on-demand database service, for users accessing the on-demand database service via user systems 312, or for third party application developers accessing the on-demand database service via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global internetwork of networks often referred to as the “Internet” with a capital “I.” That network will be used in many of the examples herein. However, it should be understood that the networks used with the embodiment described herein use are not so limited, although TCP/IP is a frequently implemented protocol.

User systems 312 might communicate with system 316 using TCP/IP and, at a higher network level, use other common Internet protocols to communicate, such as hypertext transfer protocol (HTTP), file transfer protocol (FTP), Andrew file system (AFS), wireless application protocol (WAP), etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as to provide related data, code, forms, webpages and other information to and from user systems 312. The application servers are also configured to store to, and retrieve from, a database system related data, objects, and Webpage content. With a multi-tenant system, data for multiple tenants may be stored in the same physical database object. Tenant data may be arranged such that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party application developer) software applications, which may or may not include CRM, may be supported by the application platform 318, which manages the creation and storage of the applications into one or more database objects, and executing of the applications in a virtual machine in the process space of the system 316. The terms “application,” “software application,” “software package,” “software code,” and “program code” are used interchangeably.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, liquid crystal display (LCD) monitor, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where more than one is present) and all of their components might be operator configurable using application(s) including computer code to run using a central processing unit such as processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a read-only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., object oriented database management system (OODBMS) or rational database management system (RDBMS)) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 illustrates a block diagram of another example environment 310, which may be used to implement the embodiments described herein. FIG. 4 also illustrates elements of system 316 and various interconnections, according to one embodiment. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, user interface (UI) 430, application program interface (API) 432, PL/Salesforce.com object query language (PL/SOQL) 434, save routines 436, application setup mechanism 438, applications servers 400₁-400_{N}, system process space 402, tenant process spaces 404, tenant management process space 410, tenant storage area 412 (labeled “Tenant Space 412” in FIG. 4), user storage 414 (labeled “Tenant Data 414” in FIG. 4), and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown in FIG. 3, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes and to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410, for example. Invocations to such applications may be coded using PL/SOQL 434 that provides a programming language style interface extension to API 432. Invocations to applications may be detected by one or more system processes, which manage retrieving application metadata 416 for the subscriber, making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer control protocol and Internet protocol (TCP/IP) are typical protocols for communicating between application servers 400 and the database system. However, it will be apparent to one skilled in the art that other transport protocols may be used to optimize the system depending on the network connection used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles the storage of, and access to, different objects, data and applications across disparate users and organizations.

As an example of storage, one tenant might be a company that employs a sales force where each salesperson uses system 316 to manage his or her sales process. Thus, a user might maintain contact data, leads data, customer follow-up data, performance data, goals and progress data, etc., all applicable to that user's personal sales process (e.g., in tenant data storage 322). In an example of an MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more structured query language (SQL) statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the embodiments described herein. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for providing administrative capabilities in a multi-tenant database system, the method comprising:
providing a portal for a database system to a user;
providing administrative capabilities through the portal; and
enabling the user to manage objects in the database system using the administrative capabilities.

2. The method of claim 1, wherein the administrative capabilities comprise disabling capabilities.

3. The method of claim 1, wherein the administrative capabilities comprise merging capabilities.

4. The method of claim 1, wherein the administrative capabilities comprise transferring capabilities.

5. The method of claim 1, wherein the objects comprise accounts.

6. The method of claim 1, wherein the objects comprise contacts.

7. The method of claim 1, wherein the user is an external user.

8. A computer-readable storage medium carrying one or more sequences of instructions thereon for providing administrative capabilities in a multi-tenant database system, the instructions when executed by a processor cause the processor to:
provides a portal for a database system to a user;
provides administrative capabilities through the portal; and
enables the user to manage objects in the database system using the administrative capabilities.

9. The computer-readable storage medium of claim 8, wherein the administrative capabilities comprise disabling capabilities.

10. The computer-readable storage medium of claim 8, wherein the administrative capabilities comprise merging capabilities.

11. The computer-readable storage medium of claim 8, wherein the administrative capabilities comprise transferring capabilities.

12. The computer-readable storage medium of claim 8, wherein the objects comprise accounts.

13. The computer-readable storage medium of claim 8, wherein the objects comprise contacts.

14. The computer-readable storage medium of claim 8, wherein the user is an external user.

15. An apparatus for providing administrative capabilities in a multi-tenant database system, the apparatus comprising:
a processor; and
a storage device storing one or more stored sequences of instructions which when executed by the processor cause the processor to:
provides a portal for a database system to a user;
provides administrative capabilities through the portal; and
enables the user to manage objects in the database system using the administrative capabilities.

16. The apparatus of claim 15, wherein the administrative capabilities comprise disabling capabilities.

17. The apparatus of claim 15, wherein the administrative capabilities comprise merging capabilities.

18. The apparatus of claim 15, wherein the administrative capabilities comprise transferring capabilities.

19. The apparatus of claim 15, wherein the objects comprise accounts.

20. The apparatus of claim 15, wherein the objects comprise contacts.
